(19) United States
(12) Patent Application Publication
(10) Pub. No.: US 2006/0235931 A1
(43) Pub. Date: Oct. 19, 2006

(54) System for two-way exchange of personal data over mobile telephone networks

(76) Inventors: Garry Eddy Ruthe, Vancouver (CA); Peter L. Smyth, Vancouver (CA); Patrick Martin Scheltgen, South Surrey (CA)

Correspondence Address: Garry Ruthe;#307, 611 West 13th Avenue, Vancouver, BC, V5Z 1N8, CA

(21) Appl. No.: 11/405,707

(22) Filed: Apr. 18, 2006

Related U.S. Application Data
(60) Provisional application No. 60/672,438, filed on Apr. 19, 2005.

(51) Int. Cl. G06F 15/16

(52) U.S. Cl. 709/206; 370/352

(57) ABSTRACT

A system for two-way exchange of personal data over mobile telephone networks is disclosed. In one embodiment, the system comprises a mobile telephone running a Mobile Translator Program, a Wireless Transport Gateway embodying a Wireless Transport Protocol and connected to an Application Server, said Application Server including a Data Repository, and running a Web Translator Program wherein the mobile telephone is capable of sending or receiving a message comprising personal data to or from the Application Server, via the Wireless Transport Protocol and Wireless Transport Gateway.

### CROSS REFERENCE TO RELATED APPLICATIONS

This application claims priority benefit of U.S. Provisional Application No. 60/672,438 filed Apr. 19, 2005.

### FIELD

The present disclosure relates to systems for exchange of personal data, and more particularly to a system capable of two-way exchange of personal data over mobile telephone networks.

### BACKGROUND

Modern wireless mobile telephones have come into common use in many parts of the world for both personal and business use. Most of these mobile telephones are capable of storing frequently used information of the user, including personal data such as contact data for the user's contacts, and/or the user's schedule or calendar event data. Similar such contact data and/or calendar event data may be stored in other non-wireless personal devices such as personal digital assistant devices (PDAs) or home or office computer systems.

Users of personal devices frequently wish to exchange and store personal data such as contact data or calendar event data with other users to facilitate social or business interaction or connectivity, or to create a list of their contact or calendar event data for personal reference. As part of one solution to facilitate the transfer of such personal data between users in non-wireless devices, standards for formatting personal data have been developed, two of the most common of which have been defined by the Internet Mail Consortium (IMC). The vCard and vCalendar (or vCal) standards were defined by the IMC to standardize the format and content of contact data and calendar event data respectively, and are one routinely used means to transfer personal data between non-wireless personal devices by means such as electronic mail (email).

Users of mobile telephones also wish to be able to exchange personal data electronically with other mobile telephone users, or with other sources of personal data such as non-wireless devices, to facilitate similar purposes to those described above (social or business interaction, or reference collection of personal data). One existing solution for the transfer of personal data to and from mobile telephones involves the connection of the mobile telephone to another personal device by a physical connection such as a transfer cable to transfer personal data to or from another personal device. Alternatively, proximity-based short range transport technologies such as Bluetooth or Infrared Data Transfer may be used by some compatible mobile telephones to transfer personal data to and from another compatible personal device within a limited short distance, typically no more than several meters.

The limitations of such existing methods for transferring personal data to and from mobile telephones include the inability to exchange personal data with other mobile telephone users who may be far away from each other, or the inability to transfer personal data between non-similar or non-compatible mobile telephone models. The present inventive system seeks to address some of the shortcomings of the prior art in the area of personal data exchange and storage for mobile telephones.

### SUMMARY OF THE INVENTION

In a first embodiment, the present inventive system for two-way exchange of personal data over mobile telephone networks may comprise a mobile telephone running a Mobile Translator Program, a Wireless Transport Gateway embodying a Wireless Transport Protocol and connected to an Application Server, said Application Server including a Data Repository, and running a Web Translator Program wherein the mobile telephone may be capable of sending or receiving a message comprising personal data to or from the Application Server, via the Wireless Transport Protocol and Wireless Transport Gateway.

The Mobile Translator Program may preferably reside and run on the mobile telephone, and may be capable of translating an incoming message from the Application Server via the Wireless Transport Gateway by means of the Wireless Transport Protocol comprising personal data to a format suitable for internal storage of the personal data in the memory of the mobile telephone, and to access the memory of the mobile telephone to store the personal data. Similarly, the Mobile Translator Program may be capable of translating internally stored personal data into a format suitable for transmission to the Application Server via the Wireless Transport Gateway by means of the Wireless Transport Protocol.

The Web Translator Program may typically run on the Application Server and may be capable of translating an incoming or outgoing message to or from the mobile telephone via the Wireless Transport Gateway and Wireless Transport Protocol comprising personal data to or from a format suitable for storage of the personal data in the Data Repository, and to access the Data Repository to store or retrieve the personal data. Similarly, the Web Translator Program may be capable of translating personal data stored in the Data Repository into a format suitable for transmission to the mobile telephone via the Wireless Transfer Gateway and Wireless Transport Protocol.

The Web Translator Program may additionally be specifically capable to determine the message format required for compatibility with a particular mobile telephone and corresponding Mobile Translator Program running on the mobile telephone, and to translate an outgoing message comprising personal data into a format compatible for reception and translation by the particular mobile telephone and Mobile Translator Program receiving the message.

In a second embodiment of the invention, a method for two-way exchange of personal data over mobile telephone networks is provided comprising the steps of:

providing a mobile telephone running a Mobile Translator Program capable of translating an incoming/outgoing message comprising personal data to/from a format suitable for internal storage of the personal data in the memory of the mobile telephone and accessing the memory of the mobile telephone to store/retrieve the personal data; and

providing a Wireless Transport Gateway embodying a Wireless Transport Protocol capable of sending/receiving a message comprising personal data to/from the mobile telephone by means of the Wireless Transport Protocol; and

providing an Application Server including a Data Repository connected to the Wireless Transport Gateway capable of sending/receiving a message comprising personal data to/from the mobile telephone via the Wireless Transport Gateway and Wireless Transport Protocol, and running a Web Translator Program, wherein the Web Translator Program is capable of translating an incoming/outgoing message comprising personal data to/from a format suitable for storage in the Data Repository. The Web Translator Program may be additionally capable to determine the message format required for compatibility with a particular mobile telephone and corresponding Mobile Translator Program running on the mobile telephone, and to translate an outgoing message comprising personal data into a format compatible for reception and translation by the particular mobile telephone and Mobile Translator Program receiving the message.

### BRIEF DESCRIPTION OF THE DRAWINGS

FIG. 1 is a schematic depiction of a first embodiment according to the present inventive system for two-way exchange of personal data over mobile telephone networks.

FIG. 2 is a schematic depiction of a further embodiment according to the present inventive system comprising additional components and functionality.

FIG. 3 is a schematic depiction of a particular embodiment according to the present invention.

### DETAILED DESCRIPTION OF SEVERAL EMBODIMENTS

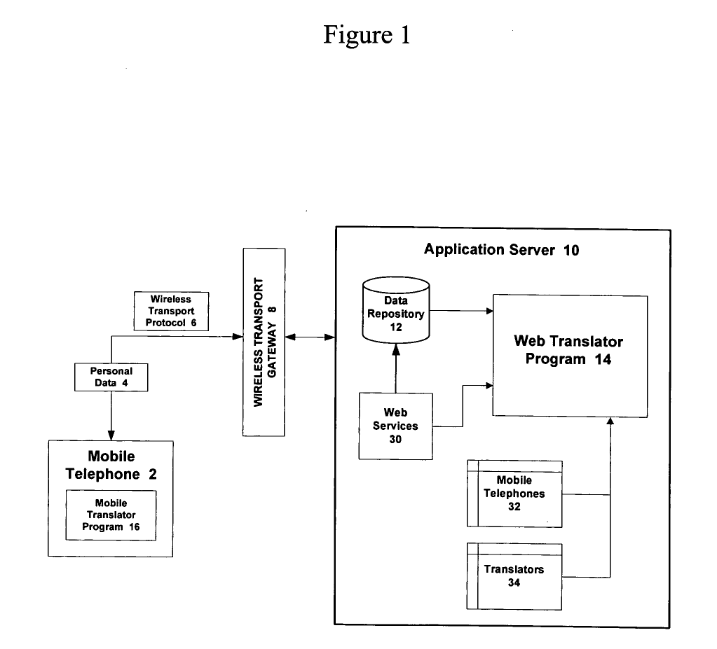

In a first embodiment according to the present inventive system for two-way exchange of personal data over mobile telephone networks as depicted in FIG. 1, the system comprises a mobile telephone 2 running a Mobile Translator Program 16, a Wireless Transport Gateway 8 embodying a Wireless Transport Protocol 6, and an Application Server 10 including a Data Repository 12 and running a Web Translator Program 14, wherein the mobile telephone is operable of sending or receiving a Message comprising personal data 4, to or from the Wireless Transport Gateway 8 by means of the Wireless Transport Protocol 6, and wherein the Wireless Transport Gateway 8 is connected and operable to send or receive the Message comprising personal data 4 to or from the Application Server 10. The Web Translator Program 14 may additionally be specifically capable to determine the message format required for compatibility with a particular mobile telephone 2 and corresponding Mobile Translator Program 16 running on the mobile telephone 2, and to translate an outgoing message comprising personal data 4 into a format compatible for reception and translation by the particular mobile telephone 2 and Mobile Translator Program 16 receiving the message.

In an optional example of the first embodiment, the inventive system may additionally comprise a Web Services module 30 running on the Application Server 10 as shown in FIG. 1. The system may also comprise Mobile Telephones table 32 and Translators table 34 which may be utilized by the Web Translator Program 14 to determine the message format required for compatibility with mobile telephone 2 and corresponding Mobile Translator Program 16 running on mobile telephone 2.

In this optional example of the first embodiment, the Web Services module 30 manages incoming/outgoing message traffic to ensure that personal data 4 sent to the Application Server 10 via the Wireless Transport Gateway 8 is parsed and translated properly for storage in the Data Repository 12 and personal data 4 sent to the mobile telephone 2 is formatted and sent out via the Wireless Transport Gateway 8 using a Wireless Transport Protocol 6 as per the specific capabilities of the mobile telephone 2 and Mobile Translator Program 16.

The mobile telephone 2 may be chosen from any commercially available mobile telephone that supports the sending and receiving of digital data messages by means of a Wireless Transport Protocol commercially implemented by a mobile telephone carrier, and capable of storing personal data in internal memory on the mobile telephone. The majority of currently commercially available digital mobile telephones support the transmission of digital data messages by at least one Wireless Transport Protocol, and also comprise internal memory for storage of personal data such as in a stored phonebook, contact list, or other personal information management memory for storing personal data of the telephone user. Common types of personal data to be sent or received from/by a mobile telephone include contact data (such as names and telephone numbers, as well as additional contact information such as email addresses, postal addresses, etc.) and calendar event data (such as appointments, events and tasks, etc.). In particular, commonly used personal data may be collected according to standardized formats such as vCard and vCal, and such vCard and vCal personal data may be sent/received by a mobile telephone as a data message.

The Wireless Transport Protocol 6 may comprise any known digital wireless protocol that supports the sending and receiving of digital data messages on a mobile telephone network between mobile telephones and/or other wireless devices such as wireless modems. Preferably, the Wireless Transport Protocol 6 may be chosen from a common digital wireless protocol in relatively wide use on mobile telephone networks. Common Wireless Transport Protocols, which are currently widely commercially supported by multiple mobile telephone carriers and on multiple mobile telephone network technology platforms (such as GSM, GPRS, CDMA, TDMA, CDMA2000, WCDMA, EDGE and UMTS), include Short Message Peer-to-Peer Protocol (SMPP), Wireless Application Protocol (WAP), and Hyper Text Transport Protocol (HTTP). In particular, short messaging service (SMS) messages utilizing SMPP are widely supported by commercially available mobile telephones.

The Mobile Translator Program 16 may comprise any software or firmware program suitable for running on a digital mobile telephone and capable of translating an incoming message comprising personal data into a format suitable for storing the personal data in the memory of the mobile telephone on which the Mobile Translator Program 16 is running. In one embodiment, the Mobile Translator Program 16 may comprise a software or firmware program loaded on the mobile telephone 2 by the manufacturer or carrier supplying the mobile telephone, before it is sold to the user. In such a case, the Mobile Translator Program 16 may be capable of sending/receiving messages comprising personal data (such as vCard or vCal data for example) and of translating such messages into a format suitable for storing the personal data in the memory of the mobile telephone. Typically in such an embodiment wherein the Mobile Translator Program 16 is pre-loaded on the mobile telephone 2 prior to supply to the user, the Mobile Translator Program 16 may only be capable of translating personal data to/from one specific format of message suitable for one specific application of a Wireless Transport Protocol. In such a case, it is an objective of the present inventive system to provide a Web Translator Program capable of determining the message format and Wireless Transport Protocol compatible with the mobile telephone and pre-loaded Mobile Translator Program, to ensure compatibility of personal data messages sent/received to/from the mobile telephone. In the simplest case of the present embodiment, such a pre-loaded Mobile Translator Program 16 may be capable only of translating an incoming/outgoing personal data message into/from plain text which may be stored/retrieved in the memory of the mobile telephone (and in particular the contact or other personal data portion of the memory) by non-automatic means through manipulation of the mobile telephone user interface by the user of the telephone.

In another embodiment, a Mobile Translator Program 16 particularly adapted for use with the present inventive system may be loaded on the mobile telephone 2, typically (but not necessarily) after the manufacture of the telephone. Such an adapted Mobile Translator Program 16 may preferably be loaded on the mobile telephone 2 over the wireless mobile telephone network, such as by means of the Wireless Transport Protocol, such that a physical connection or close proximity to the mobile telephone is not required. Such adapted Mobile Translator Program may preferably be tailored to the particular mobile telephone with which it will be used, such that the Mobile Translator Program is capable to translate incoming/outgoing personal data messages and provide user friendly access to the personal data storage on the mobile phone such that the user may quickly and easily send/receive personal data through the inventive system. Such a tailored Mobile Translator Program may be particularly suited for implementation in mobile telephones utilizing commonly available operating systems where the Mobile Translator Program may be written to be run on the operating system in use on the mobile telephone. Such common operating systems currently in use in mobile telephones include but are not limited to Symbian, Palm, Microsoft, Linux and proprietary operating systems used by individual mobile phone manufacturers. The Mobile Translator Program may be written using standard languages such as Java, Visual Basic, C++, BREW or other known commercial languages as may be required by the operating system in use on the mobile telephone.

The Wireless Transport Gateway 8 may comprise any known wireless gateway device suitable for receiving and transmitting messages comprising personal data by means of a Wireless Transport Protocol 6, over an existing digital mobile telephone network. Such Wireless Transport Gateway 8 is preferably suitable for easy connection to the Application Server 10 for sending messages to/from the Application Server for transmission/reception over the wireless mobile telephone network via the Wireless Transport Protocol 6. Such suitable devices for the Wireless Transport Gateway 8 may comprise electronic connection and switching means and a wireless communication device such as a wireless modem, particularly such as a GSM or CDMA modem or wireless data card. Alternatively, the Wireless Transport Gateway may comprise a direct connection using an SMPP gateway supported by a mobile carrier or third party. Examples of such SMPP gateways may include SMS or MMS gateways supported by a mobile carrier which may be accessible such as through the Internet via connection with an Internet server connected to such gateway.

The Application Server 10 may preferably be a computer server system (may include multiple interconnected computer servers) suitable for including the Data Repository 12 and for running the Web Translator Program 14. The Application Server 10 may also preferably be chosen to be suitable for easy connection to the Wireless Transport Gateway 8 as described above, for transmission/reception of personal data messages over the mobile telephone network.

The Web Translator Program 14 may preferably be run on the Application Server and is capable of translating personal data such as may be stored in the Data Repository 12 to a personal data message format suitable for sending to a mobile phone 2 over a wireless network, via the Wireless Transport Gateway 8 and by means of the Wireless Transport Protocol 6. The Web Translator Program 14 is also capable to translate personal data messages received from a mobile telephone 2 into personal data in a format suitable for easy storage in the Data Repository 12. The Web Translator Program 14 is preferably also capable to translate a personal data message received from one mobile phone in a first format, to a second format suitable for transmission to a second mobile phone which may require a second format to ensure compatibility with the Mobile Translator Program running on the second mobile phone. Additionally, in the case where the Mobile Translator Program running on a mobile telephone sending or receiving a message to/from the Application Server is limited to allow only plain text format personal data message transmission/reception, the Web Translator Program 14 may preferably be capable of receiving a first message in plain text format comprising personal data desired to be stored in the Data Repository, or for re-transmission via the Wireless Transport Gateway 8 and Wireless Transport Protocol 6 to another mobile telephone 2, and for further receiving a second consecutive message from the plain-text-only capable mobile telephone 2, wherein the second consecutive message may comprise the user identification or mobile telephone number of the intended recipient of the personal data comprised in the first message, wherein the Web Translator Program 14 may then translate the personal data content of the first message into the format required by the mobile telephone or Data Repository recipient identified in the second message, and initiate transfer of the personal data for storage in the correct user account in the Data Repository 12, or for transmission as a personal data message to the recipient mobile telephone by means of the Wireless Transport Gateway 8 and Wireless Transport Protocol 6.

The Data Repository 12 may be selected from known computer data storage solutions capable of storing personal data. The Data Repository 12 may preferably store personal data in a common data format (such as a text format in a database configuration) and may store multiple collections of personal data separated into accounts belonging to individual mobile telephone users. Such accounts may be identified by a unique user identity incorporating such standard user identifiers comprising name, account identification, and password. The Data Repository 12 may also preferably store details regarding the type or model of mobile telephone and corresponding Mobile Translator Program in use by an individual user, such that this mobile telephone specific identification may be provided to the Web Translator Program 14 to determine the translation requirements for incoming/outgoing messages to ensure compatibility of the personal data message format with the specific mobile telephone to/from which the personal data message is associated. In an optional embodiment, these mobile telephone details may be stored in Mobile Telephones table 32, and details pertaining to Mobile Translator programs may be stored in Translators table 34.

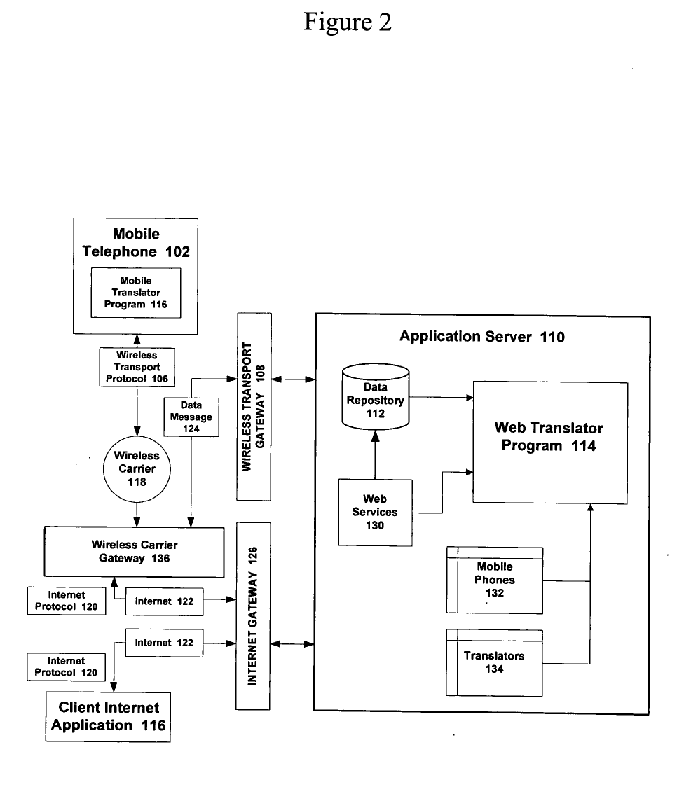

In a further embodiment of the present inventive system, as depicted in FIG. 2, several additional features and functionalities are disclosed, in addition to the aspects of the first embodiment of the inventive system disclosed above. The main components of such further inventive embodiment as depicted in FIG. 2, namely the mobile telephone 102, Mobile Translator Program 116, Wireless Transport Protocol 106, Wireless Transport Gateway 108, Application Server 110, Web Translator Program 114 and Data Repository 112 may be essentially similar to their counterpart components in the first embodiment as depicted in FIG. 1 and described above. In addition to the main components immediately previously described, the further embodiment of FIG. 2 may comprise a Client Internet Application 124, which may connect to the Application Server 110 to access personal data stored in the Data Repository 112, by means of connection through the Internet 122 via any known Internet Protocol 120, to an Internet Gateway 126 which may be connected to the Application Server 110. The further embodiment depicted in FIG. 2 may also comprise a Wireless Transport Protocol 106 to facilitate connection of the mobile telephone 102 (and corresponding Mobile Translator Program 116) to the Application Server 110 (and corresponding Web Translator Program 114) with access to personal data in the Data Repository 112 through a mobile telephone Wireless Carrier 118, connecting with an Internet Gateway 126 (which is connected to the Application Server 110) through the Internet 122 using an Internet Protocol 120.

The Internet Protocol 120 and Internet Gateway 126 described above may be selected from commercially available technology suitable for transmitting personal data between a Client Internet Application 124, or a mobile telephone 102 through a Wireless Carrier 118 and the Application Server 110, via the Internet.

The Client Internet Application 124 may preferably be capable to provide secure private access (secured such as by common internet security applications comprising encrypted password protected account access) for a mobile telephone user to personal data stored in the telephone user's account in the Data Repository 112. In particular, the Client Internet Application 124 may preferably allow a mobile telephone user to input personal data comprising contact data, and calendar event data (which may preferably be in the vCard and vCal standard formats respectively) from a personal device (comprising personal computer, personal digital assistant, or other non-wireless electronic device capable of transmitting personal data over the Internet 122) running the Client Internet Application 124 for receipt by the Application Server 110, and translation into a common storage format by the Web Translator Program 114 for storage in the telephone user's account in the Data Repository 112. The Client Internet Application 124 may also preferably be compatible with electronic organizer software commonly used to store collections of personal data such as contact lists and/or calendar data on personal devices, such as Microsoft Outlook, or Yahoo! Address Book, such that the personal data stored in such electronic organizer software may be easily transmitted by the Client Internet Application 124 and translated for storage in the Data Repository 112. In some embodiments, such personal data from electronic organizer software such as Microsoft Outlook or Yahoo! Address Book may alternatively be transmitted to the Web Translator Program in the form of standardized formatted personal information such as vCard/vCal messages. The Client Internet Application 124 may further preferably be capable of accessing personal data stored in a mobile telephone user's account in the Data Repository 112 and initiating transmission of a personal data message to any mobile telephone 102, including the telephone of the user. As described above, in such a case the Web Translator Program 114 is preferably capable of determining the format required for preferred reception and in-telephone storage of the outgoing personal data message based on the type of mobile telephone 102 and corresponding Mobile Translator Program 104 in use by the intended recipient of the personal data message. The Web Translator Program 114 is preferably then capable to translate the personal data message from the common storage format of the Data Repository 112, into the preferred reception format, and to transmit the personal data message to the recipient mobile telephone 102 via the Wireless Transport Gateway 108 and Wireless Transport Protocol 106. The Client Internet Application 124 is preferably also capable to access personal data stored in a mobile telephone user's account in the Data Repository 112 which was transmitted from a mobile telephone 102 (including the mobile telephone belonging to the account user) via the Mobile Translator Program 104, Wireless Transport Protocol 106, and Wireless Transport Gateway 108 to the Application Server 110 and translated for storage in the Data Repository 112 by the Web Translator Program 114.

In an optional embodiment as depicted in FIG. 2, the inventive system may additionally comprise a Web Services module 130 running on the Application Server 110. The system may also comprise Mobile Telephones table 132 which may store details pertaining to configurations of mobile telephones, and Translators table 134 which may store details pertaining to Mobile Translator programs on mobile telephones. Mobile Telephones table 132 and Mobile Translators table 134 may be utilized by the Web Translator Program 114 to determine the message format required for compatibility with mobile telephone 102 and corresponding Mobile Translator Program 116 running on mobile telephone 102.

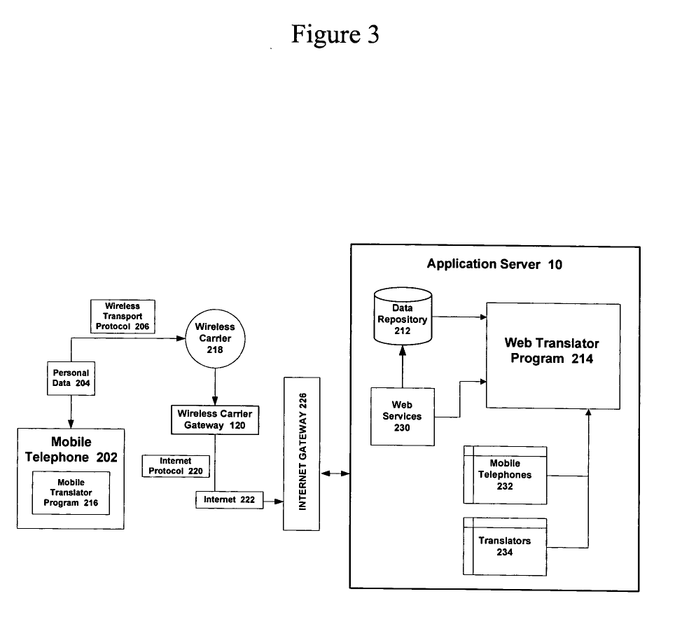

A particular exemplary embodiment of the present inventive system, as depicted in FIG. 3, may comprise components similar to their counterpart components in the second embodiment as depicted in FIG. 2 and described above. Such components may comprise mobile telephone 202, Mobile Translator Program 216, Wireless Transport Protocol 206, Wireless Carrier 218, Internet Protocol 220, Internet 222, Internet Gateway 226, Application Server 10, Web Translator Program 214 and Data Repository 212, connected to permit transmission of a message comprising personal data 204. In the present particular embodiment, a WAP protocol may be utilized as the Wireless Transport Protocol 206 to facilitate connection of the mobile telephone 202 to the personal data in a mobile telephone user's account in the Data Repository 212 by means of a WAP phonebook application running as the Mobile Translator Program 216 on the mobile telephone 202. Such connection between the mobile telephone 202 and the Data Repository 212 may be made as depicted in FIG. 3 via the WAP phonebook Mobile Translator Program 216 communicating via the WAP Wireless Transport Protocol 206 to the Wireless Carrier 218 which connects via an Internet Protocol 220 through the internet 222 to an Internet Gateway connected to the Application Server 10 running the Web Translator Program 214 and therethrough to the Data Repository 212. In such an embodiment, the user of the mobile telephone 202 may use the WAP phonebook protocol to access personal data from their user account in the Data Repository 212, and then select and transfer the selected personal data to another mobile telephone user's telephone via any of the connection/transmission options described in the previous embodiments via the translation and routing features of the Web Translator Program 214 running on the Application Server 10. As previously described, in the present particular embodiment, such transferred personal data message 204 may be translated by the Web Translator Program 214, prior to transmission to the other mobile telephone user, into a message format suitable for user friendly reception and translation by the Mobile Translator Program 216 running on the other user's mobile telephone 202. Such capability of the present inventive system to allow one mobile telephone user to easily and wirelessly access personal data stored in their user account in the Data Repository 212 and wirelessly transmit such personal data to another mobile telephone user for reception in a preferred format by the recipient's mobile telephone is a particular objective of the present invention.

In an optional embodiment as depicted in FIG. 3, the inventive system may additionally comprise a Web Services module 230 running on the Application Server 10. The system may also comprise Mobile Telephones table 232 which may store details pertaining to configurations of mobile telephones, and Translators table 234 which may store details pertaining to Mobile Translator programs on mobile telephones. Mobile Telephones table 232 and Mobile Translators table 234 may be utilized by the Web Translator Program 214 to determine the message format required for compatibility with mobile telephone 202 and corresponding Mobile Translator Program 216 running on mobile telephone 202.

The present invention has been described above with reference to certain disclosed embodiments. The scope of the present invention is not to be limited to those particular embodiments used as examples to illustrate aspects of the invention, but rather should be considered with respect to the following claims.

What is claimed is:

1. A system for two-way exchange of personal data over mobile telephone networks comprising:
a mobile telephone running a Mobile Translator Program;
a Wireless Transport Gateway embodying a Wireless Transport Protocol, and connected to an Application Server;
said Application Server including a Data Repository, and running a Web Translator Program;
wherein the mobile telephone is capable of sending or receiving a message comprising personal data to or from the Application Server via the Wireless Transport Protocol and Wireless Transport Gateway.

2. The system according to claim 1 wherein the Mobile Translator Program is capable to translate an incoming message comprising personal data from the Application Server via the Wireless Transport Gateway and Wireless Transport Protocol to a format suitable for internal storage of the personal data in the memory of the mobile telephone, and to access the memory of the mobile telephone to store the personal data.

3. The system according to claim 2 wherein the Mobile Translator Program is additionally capable to translate personal data from the memory of the mobile telephone to a message comprising the personal data in a format suitable for transmission to the Application Server via the Wireless Transport Protocol and Wireless Transport Gateway.

4. The system according to claim 1 wherein the Web Translator Program is capable to translate an outgoing message comprising personal data from the Application Server into a format suitable for transmission to the mobile telephone via the Wireless Transport Gateway and Wireless Transport Protocol and compatible with the mobile telephone and Mobile Translator Program running on the mobile telephone to allow easy storage of the personal data in the internal memory of the mobile telephone.

5. The system according to claim 4 wherein the Web Translator Program is additionally capable to translate an incoming message comprising personal data from the mobile telephone via the Wireless Transport Protocol and Wireless Transport Gateway into a format suitable for storage in the Data Repository, and to access the Data Repository to store the personal data.

6. The system according to claim 2 wherein the incoming message comprising personal data is in the form of an unformatted text message, and the Mobile Translator Program is capable to access the memory of the mobile telephone by means of a WAP link to store the personal data.

7. The system according to claim 1, wherein the Application Server including the Data Repository, and running the Web Translator Program is additionally running a Web Services module.

8. The system according to claim 1, wherein the Application Server comprises at least one of a Mobile Telephones list and a Translators list running in conjunction with the Web Translator Program.

9. A method for two-way exchange of personal data over mobile telephone networks comprising the steps of:
providing a mobile telephone running a Mobile Translator Program capable of translating an incoming/outgoing message comprising personal data to/from a format suitable for internal storage of the personal data in the memory of the mobile telephone and accessing the memory of the mobile telephone to store/retrieve the personal data;
providing a Wireless Transport Gateway embodying a Wireless Transport Protocol capable of sending/receiving a message comprising personal data to/from the mobile telephone by means of the Wireless Transport Protocol; and
providing an Application Server including a Data Repository connected to the Wireless Transport Gateway capable of sending/receiving a message comprising personal data to/from the mobile telephone via the Wireless Transport Gateway and Wireless Transport Protocol, and running a Web Translator Program, wherein the Web Translator Program is capable of translating an incoming/outgoing message comprising personal data to/from a format suitable for storage in the Data Repository and accessing the Data Repository to store/retrieve the personal data.

10. A method for two-way exchange of personal data over mobile telephone networks comprising the steps of:
providing a first mobile telephone running a Mobile Translator Program capable of accessing personal data stored in a Data Repository via a wireless WAP protocol connection to the Data Repository through a Wireless Carrier, Internet Protocol, and an Application Server comprising the Data Repository;
providing a Wireless Transport Gateway embodying a Wireless Transport Protocol connected to the Application Server and comprised Data Repository, capable of sending/receiving a message comprising the accessed personal data to a second mobile telephone, having an internal memory, by means of the Wireless Transport Protocol; and
receiving the message comprising the accessed personal data on the second mobile telephone, said second mobile telephone running a Mobile Translator Program capable to translate the accessed personal data comprised in the message into a format suitable for internal storage of the accessed personal data in the internal memory of the second mobile telephone, and;
accessing the internal memory of the second mobile telephone to store the accessed personal data.
